(19) United States
(12) Patent Application Publication
(10) Pub. No.: US 2001/0024607 A1
(43) Pub. Date: Sep. 27, 2001

(54) Floating captive screw

(76) Inventor: Albert J. Frattarola, Swarthmore, PA (US)

Correspondence Address: Paul & Paul, 2900 Two Thousand Market Street, Philadelphia, PA, 19103, US

(21) Appl. No.: 09/803,221

(22) Filed: Mar. 9, 2001

Related U.S. Application Data
(60) Provisional application No. 60/188,406, filed on Mar. 10, 2000.

(51) Int. Cl. F16B 39/00

(52) U.S. Cl. 411/107

(57) ABSTRACT

A captive screw for securing a lever to a panel has a screw captivated on a ferrule and spring extending between the screw head and the ferrule. The ferrule is press fit into the lever. A collar is formed on the screw shank under the ferrule to limit penetration of the screw threads into the panel, so that the lever “floats” on the spring.

### CROSS-REFERENCE TO RELATED APPLICATION

This application claims the benefit of U.S. Provisional Application No. 60/188,406 filed Mar. 10, 2000, entitled “Floating Captive Screw.”

### BACKGROUND OF THE INVENTION

1. Field of the Invention

The present invention relates generally to captive screws.

2. Brief Description of the Prior Art

Captive screws are screws which are “captivated” or held within a collar or ferrule. The ferrule is mounted in a first panel or like object. The screw portion is captivated so that it can be moved perpendicular to the first panel and the screw's threads can engage a corresponding aperture in a second panel, so that the first and second panels can be secured together. However, when the panels are unscrewed and disengage, the screw is retained in the first panel. Captive screws are useful in applications where it is important to avoid dropping or losing screws during assembly or repair, such electronic devices, where lost screw can cause catastrophic electrical shorts damaging equipment.

### SUMMARY OF THE INVENTION

The present invention provides a captive screw including a ferrule, a screw, and a spring. The screw has a head, a shank adapted to pass through the ferrule, a threaded portion at the end of the shank opposite the head, and a collar formed on the shank proximate the threaded portion. The screw is captivated on the ferrule between the head and the collar. The spring extends on the shank of the screw between the head and the ferrule. Preferably, the ferrule has a generally cylindrical exterior surface having a plurality of knurls for securing the captive screw in a preformed aperture in a first structure, such as a lever. Is also preferred that the ferrule be formed with an annular collapsible ring section formed on the bottom having a generally circular opening large enough to permit the threads collar the screw to pass through but not large enough to permit the spring to pass through. When the captive screw is assembled, the annular ring section is bent upwardly to captivate the screw on the ferrule. Preferably, the ferrule has an annular lip formed on the exterior cylindrical surface proximate the top of the ferrule for limiting the penetration of the ferrule in the preformed aperture in the first structure, as well as an annular circumferential groove formed in the exterior cylindrical surface of the ferrule immediately adjacent and below the annular lip for receiving the plastic flow of material when the ferrule is pressed into the preformed aperture.

### BRIEF DESCRIPTION OF THE DRAWINGS

FIG. 1 is a side elevational view of a captive screw according to the present invention.

FIG. 2 is a side elevational view of the screw of the captive screw of FIG. 1.

FIG. 3 is a perspective view of the captive screw of FIG. 1 with the ferrule partially cut away.

FIG. 4 is a perspective view of the ferrule of the captive screw of FIG. 1.

FIG. 5 is a side elevational cross-sectional view of the ferrule of FIG. 4.

FIG. 6 is a top plan view of the ferrule of FIG. 4.

FIG. 7 is a side elevational view of the captive screw of FIG. 1, partially in section, showing the captive screw installed in a lever and panel.

### DETAILED DESCRIPTION

The present invention provides a captive screw for slideably securing a first structure such as a lever to a second structure such as a door frame or panel.

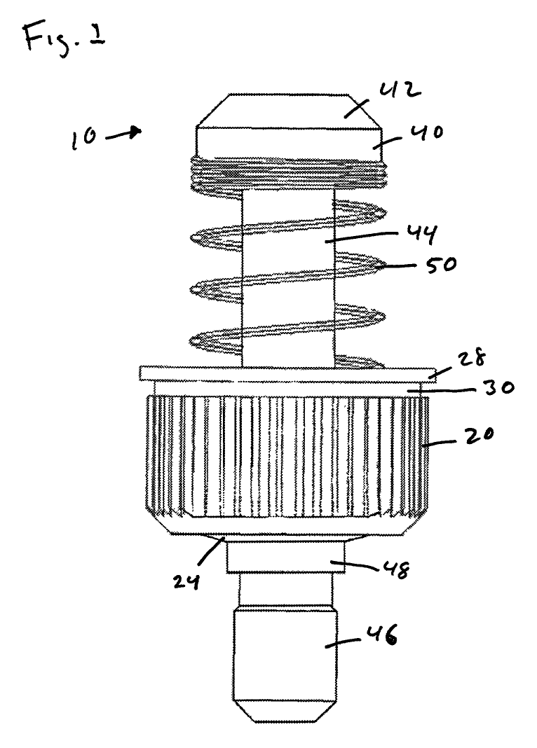

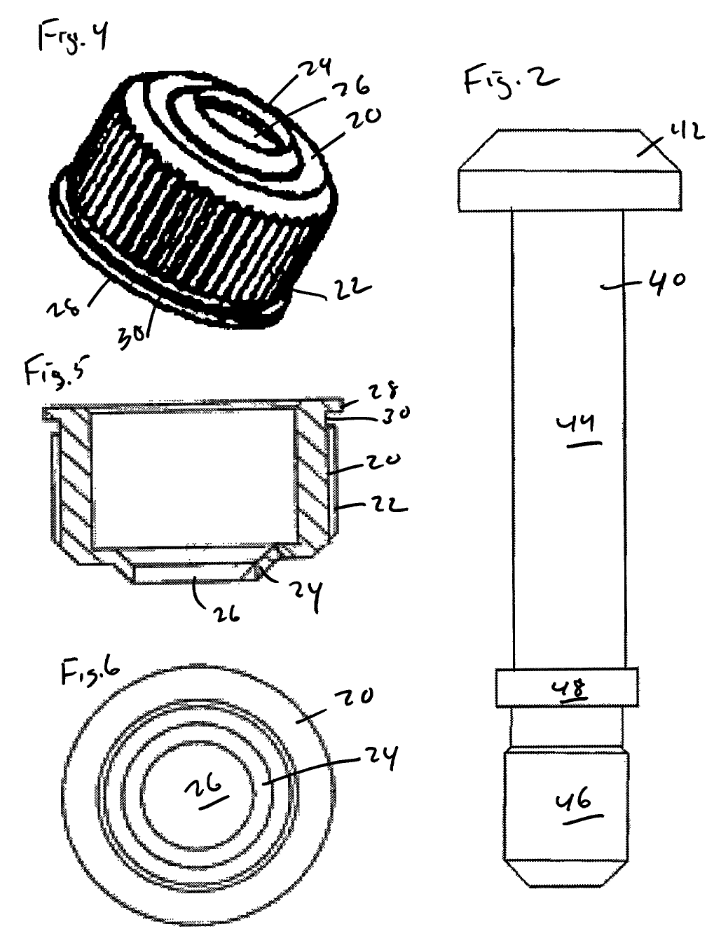

Referring now to the drawings in detail, wherein like reference numerals indicate like elements throughout the several views, there is shown in FIG. 1 a captive screw 10 according to the present invention. The captive screw 10 includes a ferrule 20, a screw 40 and a spring 50. The screw 40 (FIG. 2) includes a head 42 adapted to receive a driver (FIG. 3), a shank 44 adapted to pass through the ferrule 20, and a threaded portion 46 at the end of the shank 44 opposite the head 42. The 40 screw also includes a collar 48 formed on the shank 44 proximate the threaded portion 46.

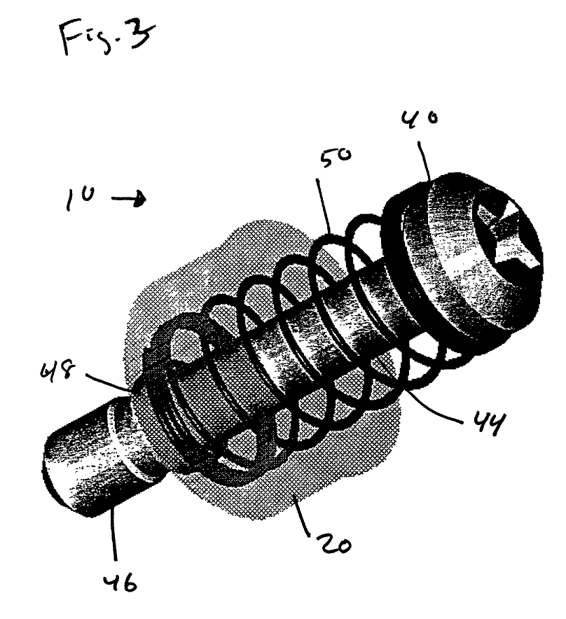

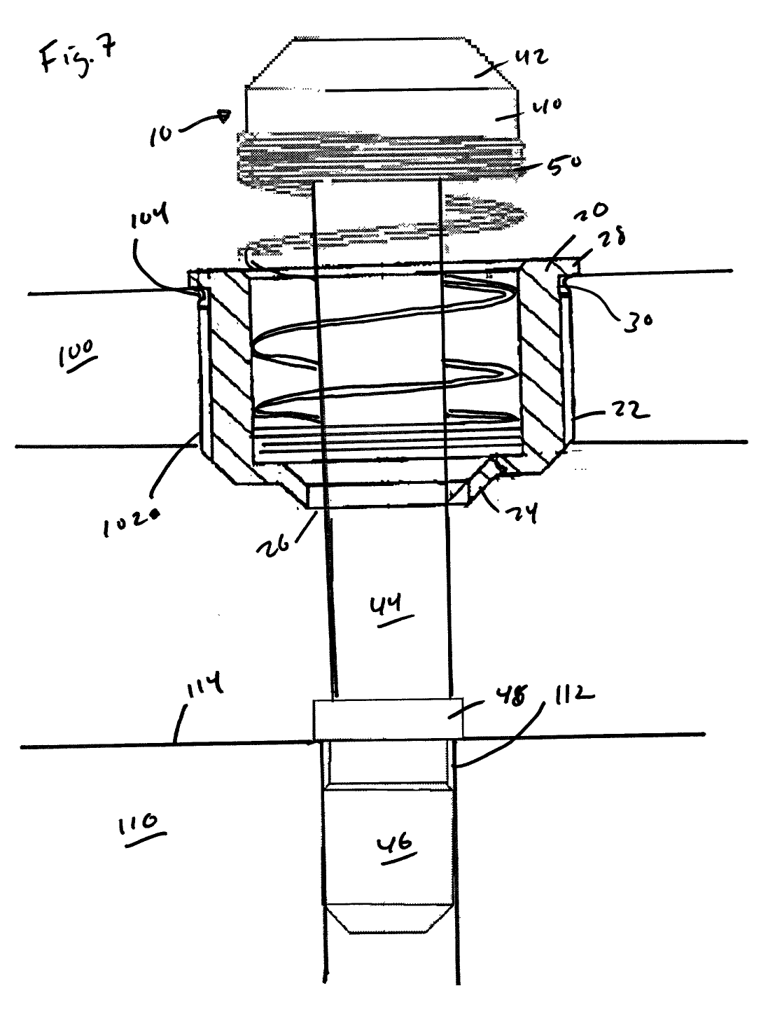

As can be seen in FIGS. 4-6, the generally cylindrical ferrule 20 has a plurality of knurls 22 formed on its exterior cylindrical surface for securing (FIG. 7) the captive screw 10 in a preformed aperture 102 in a first structure such as a lever 100 by a press fit. The threaded portion 46 of the screw 40 is intended for securing the captive screw 10 in a preformed, threaded aperture 112 formed in second structure such as a door frame or panel 100. The captive screw 10 is positioned precisely relative to the second structure by virtue of the collar 48 formed on the shank 44 of the screw 40. The collar 48 limits the depth of penetration of the screw 40 into the preformed, threaded aperture 112 in the second structure 110 by coming into contact with a surface 114 of the second structure 110 as the screw 40 is being rotationally driven into the second structure.

As can be seen in the FIGS. 4-6, the ferrule 20 is formed with an annular collapsible ring section 24 formed on the bottom. The captive screw 10 is assembled by placing the spring 50 on the screw 40 and then passing the screw 40 through the ferrule 20. The generally circular opening 26 in the bottom of the ferrule 20 is large enough to permit the threads 46 and collar 48 of the screw 40 to pass through but not large enough to permit the spring 50 to pass through. The annular ring section 24 on the bottom of the ferrule 20 is then bent upwardly, thus reducing the size of the opening 26 so the resultant opening is slightly larger than the diameter of the screw shaft 44 but smaller than both the screw head diameter and the diameter of the collar, thus captivating the screw 40 on the ferrule 20 in between the screw head 42 and the collar 48.

The ferrule 20 also has an annular lip 28 or stop formed on the exterior cylindrical surface proximate the top of the ferrule 20 for limiting the penetration of the ferrule 20 in the preformed aperture 102 in the first structure 100 (FIG. 7), as well as an annular circumferential groove 30 formed in the exterior cylindrical surface of the ferrule immediately adjacent and below the annular lip 28, for receiving the plastic flow of material 104 when the ferrule 20 is pressed into the preformed aperture. When the captive screw of 10 the present invention is installed, the collar 48 precisely limits the vertical position of the screw 40 above the second structure 110, while the first structure 100 floats above the second structure 110, while being urged towards the second structure 110 by the spring 50 of the captive screw 10.

Various other modifications can be made in the details of the various embodiments of the apparatus of the present invention, all within the scope and spirit of the invention and defined by the appended claims.

I claim:

1. A captive screw including:
a ferrule,
a screw having a head, a shank adapted to pass through the ferrule, a threaded portion at the end of the shank opposite the head, and a collar formed on the shank proximate the threaded portion; and
a spring,
the screw being captivated on the ferrule between the head and the collar, the spring extending on the shank of the screw between the head and the ferrule.

2. A captive screw according to claim 1 wherein the ferrule has a generally cylindrical exterior surface having a plurality of knurls for securing the captive screw in a preformed aperture in a first structure.

3. A captive screw according to claim 1 wherein the ferrule is formed with an annular collapsible ring section formed on the bottom having a generally circular opening large enough to permit the threads collar the screw to pass through but not large enough to permit the spring to pass through, the annular ring section being bent upwardly to captivate the screw on the ferrule during assembly of the captive screw.

4. A captive screw according to claim 2 wherein the ferrule has an annular lip formed on the exterior cylindrical surface proximate the top of the ferrule for limiting the penetration of the ferrule in the preformed aperture in the first structure.

5. A captive screw according to claim 4 wherein the ferrule has an annular circumferential groove formed in the exterior cylindrical surface of the ferrule immediately adjacent and below the annular lip for receiving the plastic flow of material when the ferrule is pressed into the preformed aperture.
